(19) United States
(12) Patent Application Publication
(10) Pub. No.: US 2025/0293887 A1
(43) Pub. Date: Sep. 18, 2025

(54) Biometric Sender Verification System for Electronic Messaging

(71) Applicant: Nicholas Owens, Sarasota, FL (US)

(72) Inventor: Nicholas Owens, Sarasota, FL (US)

(21) Appl. No.: 18/602,597

(22) Filed: Mar. 12, 2024

(51) Int. Cl. H04L 9/32; H04L 9/30

(52) U.S. Cl. CPC H04L 9/3231; H04L 9/3073

(57) ABSTRACT

A system is presented for verifying the human sender of an electronic message using biometrics and securely transmitting the verification status to recipients. The sender registers an email account and provides a biometric sample. A public/private key pair is generated to encrypt a unique account identifier. When sending a message, the user authenticates with biometrics. The account identifier is encrypted with the private key and transmitted with the email. The receiving server decrypts the identifier using the sender's public key and verifies it matches the sender address. If matched, the message is tagged as verified. The invention prevents email spoofing by binding the user's identity to their account with biometrics. Encrypted verification data prevents tampering. Recipients can trust message integrity as the expected human sender is cryptographically verified.

### FIELD OF INVENTION

The present invention relates generally to electronic messaging technologies and, more specifically, to systems and methods for verifying the authenticity of the sender of an electronic message.

### BACKGROUND OF THE INVENTION

Electronic mail (email) has become one of the most ubiquitous forms of communication, used extensively for personal and business purposes. However, from the earliest days of email technology, security vulnerabilities have existed that allow malicious actors to spoof the sender address and impersonate others. Preventing email spoofing and verifying the authenticity of the human behind an email address has remained an ongoing challenge as both email usage and threats have evolved.

In the early 1990s, email relied on Simple Mail Transfer Protocol (SMTP) which had no built-in security mechanisms. Email addresses could easily be forged with no authentication. Early approaches to secure email focused on confidentiality through encryption protocols like Pretty Good Privacy (PGP) which provided cryptography but no sender authentication.

To address spoofing and forgery, the Sender Policy Framework (SPF) was introduced in 2001 to validate domain ownership by checking sending IP addresses against DNS records. In 2002, DomainKeys Identified Mail (DKIM) improved on SPF by cryptographically signing messages to confirm the domain was authorized. However, neither solution authenticates the human sender.

The Secure/Multipurpose Internet Mail Extensions (S/MIME) standard uses public-key cryptography to provide message confidentiality, authentication, and non-repudiation. But adoption has been limited due to certificate management complexity for end-users. Usability studies have shown consistent issues with user comprehension and ability to correctly use S/MIME.

As email became the leading vector for cyberattacks, the need for authenticating humans grew. Phishing and business email compromise scams increased, using forged identities to induce users to disclose credentials or initiate fraudulent wire transfers. Spoofing sender addresses became trivial for attackers.

Existing protocols remain focused on domain-level policies rather than human identity. Some emerging standards like Domain-based Message Authentication, Reporting, and Conformance (DMARC) aim to mitigate impersonation but still lack sender authentication. Few robust technical controls exist to cryptographically bind a human identity to an email address.

It is therefore an object of this invention to bridge these gaps by using biometrics and public key cryptography to verify the human behind a message. User biometric data is paired with encrypted account identifiers to prevent spoofing even if credentials are compromised. Unlike S/MIME, key management and encryption is handled transparently on sender and recipient servers. For recipients, biometric verification provides definitive proof the expected individual authored the email. The approach enhances email integrity and provides breakthrough human-level sender validation without usability barriers.

### SUMMARY OF THE INVENTION

The following summary is an explanation of some of the general inventive steps for the system, method, devices and apparatus in the description. This summary is not an extensive overview of the invention and does not intend to limit its scope beyond what is described and claimed as a summary.

In some embodiments thereof, the present invention relates to verifying the identity of the sender of an electronic message using biometrics and cryptographic techniques. In one embodiment, when a user registers their messaging account, a biometric template is captured and stored. A public/private key pair is also generated, with the public key stored on a sending server and private key on the user's device.

To send a verified message, the user provides a fresh biometric sample that is validated against their stored template to authenticate their identity. A unique identifier associated with the user's account is encrypted locally using the private key. This encrypted identifier is transmitted with the message to the sending server.

The sending server decrypts the identifier using the registered public key and verifies it matches the user's account. This confirms the authenticated human's identity as the sender. The server then encrypts a verification status in a header before transmitting the message to receiving server(s).

On receipt, the verification status header is decrypted using a domain public key. If the status validates the sender's identity, the message can display a verified indicator. Spoofing is prevented by binding the user to their account and device with biometrics. Tampering is prevented by encrypting verification data end-to-end.

Overall, the invention enhances trust in electronic messaging by reliably verifying the human behind a message using cryptographic identity protocols. It has implications for mitigating impersonation attacks and providing definitive proof of message integrity from the expected sender.

### BRIEF DESCRIPTION OF THE DRAWINGS

The novel features believed to be characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 illustrates an administrator setting up SenderID on a DNS server from an administration device by receiving keys from an email server, creating a TXT record, and indicating setup completion.

FIG. 2 illustrates an email server setting up SenderID for a domain by generating keys, providing the public key to an administrator, and marking the domain as SenderID configured.

FIG. 3 illustrates a device registering an email address for SenderID by authenticating, receiving a delivery mechanism, generating keys, sending the public key to a server, and storing an identifier.

FIG. 4 illustrates a server registering an email address for SenderID by authenticating a device, sending a delivery mechanism, receiving keys, and sending an identifier.

FIG. 5 illustrates a device sending an authenticated email by checking if SenderID is enabled, prompting for biometrics, and sending the email with encrypted identifiers.

FIG. 6 illustrates a server sending an authenticated email by validating SenderID, decrypting identifiers, verifying against accounts, encrypting the sender address, and adding a Selector.

FIG. 7 illustrates a recipient server verifying SenderID on a received email by checking headers, retrieving keys, decrypting signatures, verifying matches, and tagging as verified.

### DETAILED DESCRIPTION OF THE PREFERRED EMBODIMENTS

Hereinafter, the preferred embodiment of the present invention will be described in detail with reference to the accompanying drawings. The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor(s) can appropriately define the terms in order to describe the invention in the best way.

It is to be understood that the form of the invention shown and described herein is to be taken as a preferred embodiment of the present invention, so it does not express the technical spirit and scope of this invention. Accordingly, it should be understood that various changes and modifications may be made to the invention without departing from the spirit and scope thereof.

In this disclosure, the term exemplary may be construed as to mean embodiments that are provided as examples.

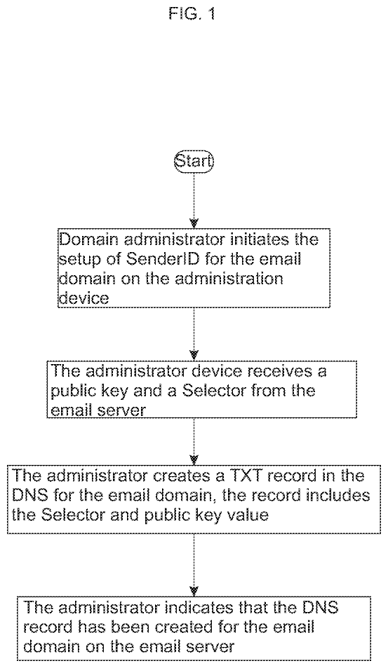

In the illustrated embodiment of FIG. 1, a method is shown for setting up the domain verification component of the SenderID protocol from an administration device. SenderID aims to authenticate the origin of email messages to prevent spoofing by cryptographically confirming the domain ownership.

The process begins with the domain administrator initiating the setup procedure for SenderID on their administration device for a particular email domain they control. This administrator device could be a computer, server, or other machine that has management privileges over the email service and domain name system (DNS) records for the domain.

The first step has the administration device contacting the email service server and requesting the initialization of SenderID for the email domain. In response, the email server generates a unique public and private key pair that will be dedicated to securing email delivery for that domain. The email server then transmits the public key portion of the pair back to the requesting administration device.

Along with the public key, the email server also generates and provides a Selector value that uniquely identifies the public key for retrieval later in the process. The Selector serves as a way to reference the correct verification key during subsequent transmission and authentication of messages from the domain.

Upon receiving the public key and Selector from the email server, the administration device then interacts with the DNS server to create a new text (TXT) record that will store the verification details. This TXT record is created specifically for the email domain that SenderID is being set up for.

Within this new TXT record, the administration device inserts the Selector value to reference the record itself, along with the public key that was obtained from the email server. By inserting this data into the DNS, it can subsequently be retrieved by any receiving email servers to validate messages.

After successfully creating the new TXT record in DNS and populating it with the SenderID verification credentials, the administrator device then sends confirmation back to the original email server that the record has been created as expected. This completes the domain configuration from the administration side.

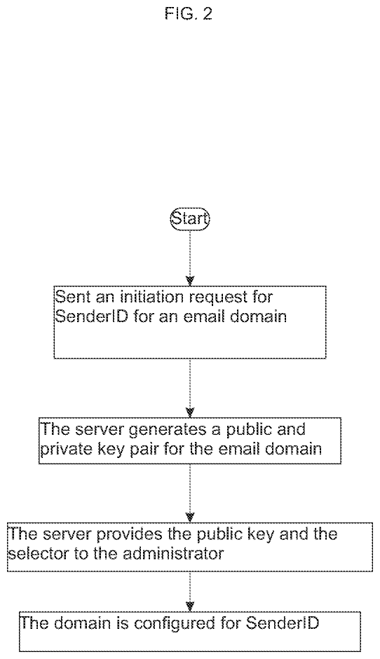

The embodiment according to FIG. 2 illustrates an embodiment for an email server setting up the SenderID domain verification process for an email domain it services. In contrast to FIG. 1 which showed client-side setup, FIG. 2 demonstrates the server-side workflow.

First, the email server receives a request to initialize SenderID protection for a particular email domain. This request could come from an administrator managing that domain.

In response, the email server generates a new public and private key pair that will be dedicated specifically to securing messages sent from email addresses in that domain. The private key is kept securely on the server while the public key will be shared externally.

A unique Selector value is also generated by the email server to identify the public key. This Selector acts as a pointer to retrieve the correct public key when validating SenderID credentials for the domain during message transmission.

The email server then provides the public key and Selector value to the administrator from the initial setup request. This allows the administrator to store the credentials in DNS as described in FIG. 1. By returning these verification parameters to the requester, the server enables the administrative side to populate DNS with the public key for other receiving servers to access. Finally, on the email server itself, the domain is marked internally as having been configured for SenderID protection. This indicates the domain now has an associated key pair generated and is ready for sending and receiving verified messages.

With these steps completed, the email domain has been fully initialized by the server to utilize SenderID for message authentication. The server generates the cryptographic parameters, coordinates with the client to store credentials in DNS, and tracks the domain as protected.

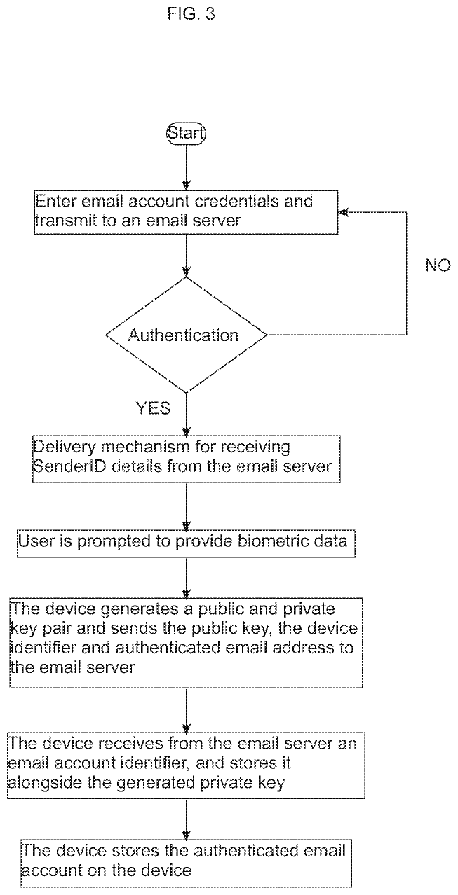

The illustration of FIG. 3 is the client-side process for registering an individual email address to utilize SenderID for identity verification when sending messages. First, the user's email client device prompts them to enter the credentials for the email account they want to register. These credentials are transmitted to the mail server for authentication.

Upon validating the supplied credentials, the mail server sends back a delivery mechanism that will allow the device to provide the necessary SenderID details to register the address. This establishes a secure channel for the upcoming key exchange. With the channel established, the user is prompted by the device to provide a biometric sample such as a fingerprint scan. This links their physical identity to the email account for enhanced verification when composing messages later.

The client device then generates a new public and private key pair that will be dedicated to signing messages sent from the authenticated email address. The private key remains stored locally. The device now transmits the public key, its own device identifier, and the authenticated email address back to the original mail server using the provided delivery mechanism. The device identifier acts as a unique token for that client.

Upon receiving these details, the mail server generates an email account identifier value that it will use internally to associate the registered public key with the email address for future reference. This identifier is sent back to the client device. The client device receives this email account identifier from the server and securely stores it locally alongside the private key that was previously generated. Finally, the client device adds the fully registered and authenticated email account into its local storage. The address is now ready for validating outgoing messages using the SenderID protocols.

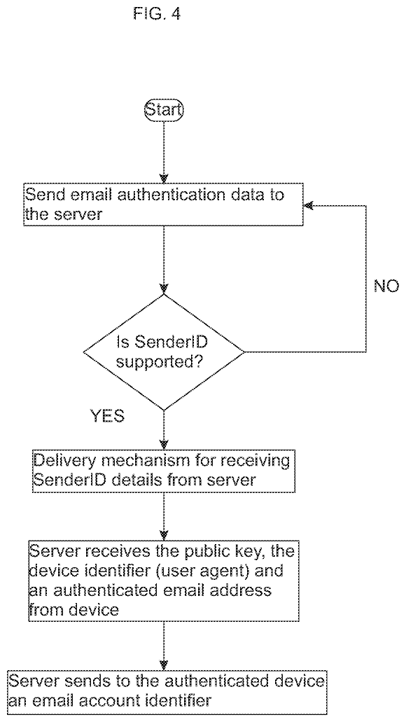

Further, the FIG. 4 demonstrates an embodiment of the server-side process for registering an individual email address for participation in the SenderID sender verification protocol. In contrast to FIG. 3 which covered client-side registration, FIG. 4 details how the mail server handles registration requests and validates users.

First, the mail server receives authentication data for an email address from a client device. This consists of the account credentials needed to validate that the user controls the email address they are attempting to register. The server checks whether the domain of the email address being registered is configured on the server to support SenderID sender verification. This ensures the server is authoritative for that domain and able to create the required cryptographic credentials.

If the domain is supported, the server transmits back to the requesting client device a delivery mechanism for securely receiving the details needed to register the address on the server. This delivery mechanism will be used to exchange keys and identifiers.

Through the provided delivery mechanism, the server receives the public key generated by the client device, as well as a unique device identifier and the email address being registered. The device identifier allows the server to distinguish keys from different client devices.

Having received the public key and identifiers from the client, the server then generates its own internal email account identifier that will uniquely represent the registered address on the server-side. This maps the address to the user's public key.

The server sends this email account identifier back to the originating client device through the established secure delivery mechanism. This completes registration by providing the client with the identifier needed to sign messages during future sending operations.

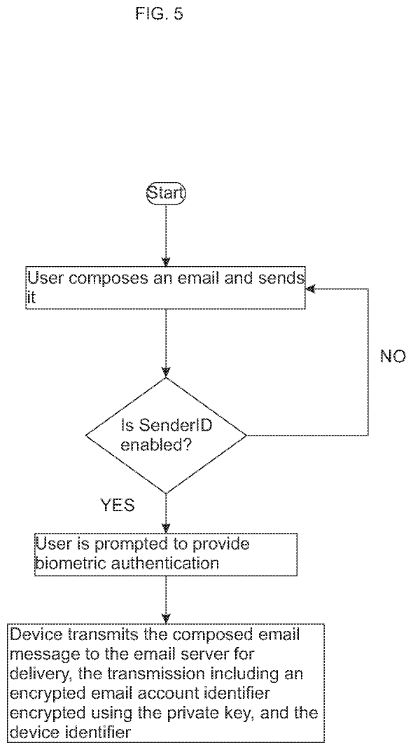

FIG. 5 illustrates an embodiment of the client-side process for sending an email message utilizing SenderID for human sender verification. In this embodiment, the client device leverages previously registered keys and biometrics to cryptographically sign the message contents and sender identity.

The process begins on a user's mail client device, where an email message has been composed via the mailbox interface and the user initiates sending, typically by pressing a send or submit button. This triggers the SenderID verification workflow.

The mail client software on the device first checks whether the email account being used to send the message has SenderID enabled. This determines if the address was previously registered and associated with identity credentials.

If the address does have SenderID enabled, the client prompts the user to provide their biometric sample, such as a fingerprint scan, which was previously stored on the device during the registration process. This biometrically authenticates the user.

After capturing and validating the user's biometric against the stored sample, the client device then retrieves the private key associated with the sending email address that was generated and kept locally during registration.

Using this private key, the device encrypts the email account identifier that was assigned by the mail server and retrieved during prior registration. This identifier cryptographically binds the message to the user.

In addition to the encrypted identifier, the device also includes its own device identifier, typically the user-agent string, which uniquely represents that client device on the network.

With the encrypted identifier and device identifier ready, the mail client finally transmits the fully composed email message to the mail server for delivery. This includes the standard email contents plus the appended SenderID verification data.

Upon receiving the message, the mail server will be able decrypt the identifier using the registered public key and verify that it matches the sending address, thereby validating that the expected human composed the message contents based on their unlocked biometrics.

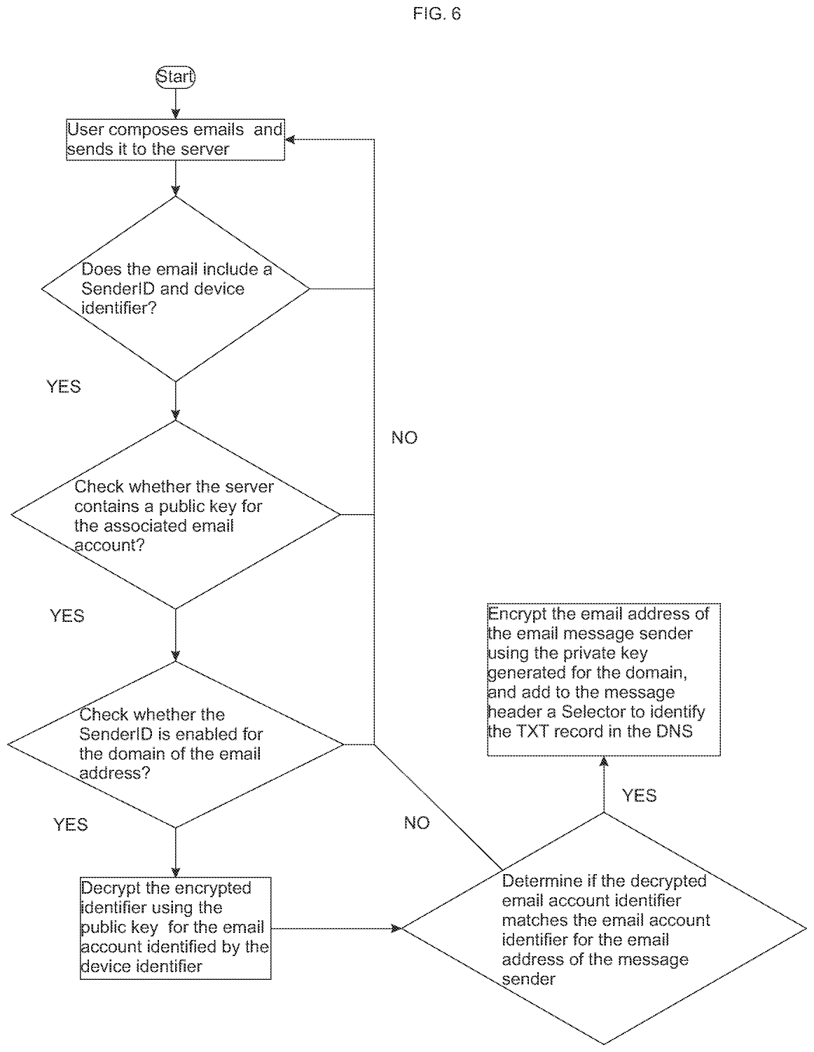

Now referring to FIG. 6, it is illustrated the server-side process for handling the sending of an email message that utilizes SenderID for cryptographic sender verification. In this embodiment, the mail server receives a message with encrypted identifiers, validates the SenderID credentials, and inserts domain-level signatures.

First, the mail server receives the composed email message itself, along with the sending device's identifier and an encrypted email account identifier appended to the message contents. The server then determines if the received message includes a valid SenderID for the email account specified in the sender address field. This involves checking that both the device identifier and encrypted email account identifier are present.

If SenderID data is included, the server next checks its local database to determine if it contains the registered public key associated with the sending email account, based on the provided device identifier.

The server also verifies that the domain of the sender address has SenderID enabled and the server is authoritative for that domain. This validates appropriate domain-level signatures can be applied.

With the public key for the sender account retrieved, the server now decrypts the encrypted email account identifier appended to the message using the public key paired to the sender's address.

This decrypted email account identifier is compared to the identifier stored for that email address and device pairing in the server's database to determine if they match. A match proves the sender owns the private key.

If the message integrity checks pass, the server then encrypts the email address of the sender using the domain's private key that was previously generated when the domain was registered for SenderID. Finally, the server adds a Signature Header to the outgoing message, containing the encrypted sender address and the Selector value identifying the public key needed to decrypt it.

By signing the domain in the header and including the Selector, receiving servers can retrieve the public key from DNS and validate the domain signature, providing end-to-end authentication.

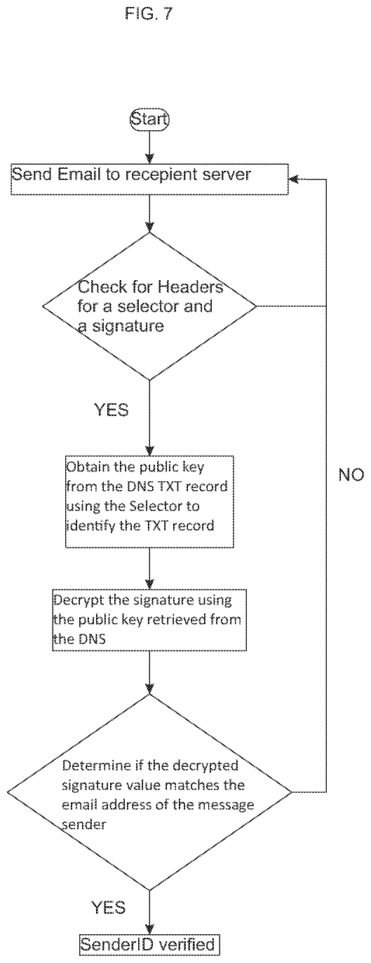

The last shown embodiment is FIG. 7 illustrates the processing steps performed by a recipient server when receiving an email message protected by SenderID to verify the authenticity of the human sender.

Initially, the recipient email server receives the incoming message over the network that was composed and sent as detailed in FIGS. 5 and 6. The server then checks if the received message contains the expected SenderID headers—specifically the Selector value pointing to the public key and the encrypted domain signature of the sender's address.

If the SenderID headers are present, the server extracts the Selector value from the message and uses it to query the DNS system to obtain the public key needed to validate the signature. The Selector indicates which TXT record in DNS stores the public key corresponding to the sending domain that was registered during initial SenderID setup as shown in FIGS. 1 and 2.

With the correct public key retrieved from DNS using the Selector, the recipient server now decrypts the encrypted signature contained in the message header using the public key. Decrypting the signature recovers the original email address of the sender that was encrypted by the sending server before transmission.

The recipient server then cross-checks if this decrypted email address matches the address populated in the From field of the received message. A match confirms integrity. If the decrypted signature aligns with the purported sender address, this verifies that the message originates from the expected domain and human sender. The email can be tagged as SenderID verified.

However, if the decrypted signature does not match the sender address, then the message failed validation and is untrustworthy. Visual indicators may denote an unverified status. An auditable database on the recipient server can log verified and unverified incoming messages to identify patterns and potential sources of fraudulent messages.

In summary, FIG. 7 outlines recipient server steps for leveraging public keys in DNS along with encrypted signatures to validate human sender identity. By retrieving domain public keys and matching signatures, recipients get end-to-end cryptographic assurance of message authenticity

For the biometric registration process, a single device approach could perform the biometric capture, template creation, storage, and authentication completely locally without needing to transmit or store data externally. This provides strong privacy and security of sensitive biometric data. Alternatively, a distributed architecture could be used where the initial biometric sampling is conducted on the sender device, then external servers or services manage the template generation, storage in secure databases, and authentication. This provides the benefits of leveraging robust external computing resources.

The determining factor between local or distributed biometric handling may depend on how much control versus convenience is desired. Local device storage maximizes user control, while external services can reduce device resource usage and management overhead.

For the multi-tiered authentication levels on the recipient side, generation of domain reputations and trust scoring could similarly occur locally on each recipient's email server. But centralizing these computations on an external reputation service enables consistency across recipients.

Localized reputation systems allow custom tuning of heuristics and policies by recipients, while centralized scoring provides uniformity. A hybrid approach could have local servers query external reputation data or archives during analysis.

Display and interpretation of the authentication indicators and levels could remain on-device, while computation of the levels themselves leverages distributed architecture for consistency and heavier processing.

In general, the specific inventions described for enhancing SenderID could be embodied in either centralized or distributed forms depending on the context. Biometric operations favor localized control; cryptography and transmission operations utilize external resources effectively.

The described embodiments could be implemented on the sender device itself or using a client-server architecture. In a single device implementation, the biometric authentication, key generation, identifier encryption, and message transmission could be performed locally on the user's device without external communication.

Alternatively, a client-server approach could distribute processing between the sender device and email servers. The sender device may capture biometrics, register accounts, and encrypt identifiers, while transmitting data to the email servers for additional verification, status encryption, and message routing. This architecture allows leveraging of more robust server computing resources.

The implementation choice may depend on factors like required processing power, data volumes, speed/latency needs, and security preferences. For user-centric operations like biometrics, local device implementation may be favored, while cryptography and transmission operations could utilize servers. The optimal balance can be driven by the use case and performance needs. But the core inventions could be realized in either centralized or distributed forms.

The present invention may be embodied as a system, method, or computer program product at any desired level of integration. The computer program product embodiments may comprise a computer readable storage medium having computer readable instructions stored thereon to cause a processor to implement aspects of the invention.

The operations and techniques described in the flowcharts, block diagrams, and combinations thereof may be implemented as computer readable instructions provided to a general purpose processor, special purpose processor, or other programmable apparatus. The instructions executing on the processors may generate means for implementing the specified functions or acts. As such, the computer readable storage medium storing the instructions may comprise an article of manufacture including instructions to direct a computer or data processing apparatus to function per the invention.

While the present disclosure describes a preferred embodiment, it should be appreciated that variations and modifications are possible within the spirit and scope of the invention as claimed. Accordingly, the applicant intends to cover reasonable alterations, uses, combinations, and equivalents that align with the underlying inventive concepts disclosed.

It should be noted that reference to singular elements can encompass plural forms, and vice versa, unless explicitly stated or clearly evident from context. Use of grammatical conjunctions is meant to express all conjunctive and disjunctive combinations possibilities, unless indicated otherwise by the context. The term “or” in particular should be understood as generally conveying “and/or”.

### INDUSTRIAL APPLICATION

The present invention has industrial applicability in communication systems where establishing the authenticity of the human source is critical. For example, the invention could be implemented in corporate email systems to combat business email compromise and prevent spoofing of executives or employees. The biometric sender verification provides definitive protection against fraudulent wire transfer requests.

In addition, financial institutions could implement the biometric sender authentication to confirm identities for sensitive transactions, mitigating risks of deception. Government and military agencies could leverage the invention to prevent impersonation of officials in classified communications, improving security. For personal messaging, users could rely on the cryptography to verify contacts and avoid spoofing.

Overall, the invention provides critical human sender verification across industries by binding user identities to accounts using biometrics and cryptography. Spoofing, impersonation, and identity deception tactics are thwarted. The secure cryptographic protocols enhance protection in any domain where confirming the authenticity of the human behind electronic communications is pivotal, spanning financial, government, personal communication, and more.

What is claimed is:

1. An electronic message sender device comprising:
a biometric module configured to capture biometric data of a user and authenticate the user against a stored biometric template;
a registration module configured to generate a public and private key pair associated with an email account registered on the sender device, and store the private key on the device;
an encryption module configured to encrypt a sender identifier using the stored private key; and
a communication module configured to transmit an electronic message including the encrypted sender identifier to an email server.

2. The sender device of claim 1, wherein the registration module is further configured to transmit the public key associated with the registered email account to the email server.

3. The sender device of claim 1, wherein the communication module is configured to receive input of an electronic message addressed from the registered email account.

4. The sender device of claim 1, wherein the biometric module, registration module, encryption module, and communication module are implemented as software executed on a processor of the sender device.

5. The system of claim 1, wherein the sender identifier comprises an email account identifier uniquely associated with the registered sender email account on the sender device.

6. The system of claim 1, wherein the recipient server is further configured to display visual indicators that the message is unverified if the decrypted verification status does not match the message sender.

7. The system of claim 1, wherein the biometric data used to authenticate the sender comprises a fingerprint scan, facial recognition scan, or iris recognition scan.

8. The system of claim 1, wherein the sending server queries a database to retrieve the stored public key associated with the registered sender device based on the received device identifier.

9. The system of claim 1, wherein the encrypted sender identifier is appended to the electronic message transmission in a dedicated verification field.

10. The system of claim 1, wherein the sending server is further configured to validate that the sender device is authorized to send messages from the sender email account.

11. The system of claim 1, wherein the encrypted verification status inserted into the message header comprises an encrypted hash value derived from the sender address.

12. The system of claim 1, wherein the recipient server is further configured to log verified and unverified messages in an auditable database.

13. A method for verifying an electronic message sender using a sender device, comprising:
capturing biometric data of a user on the sender device and authenticating the user against a stored biometric template;
generating a public and private key pair associated with a registered email account and storing the private key on the sender device;
encrypting a sender identifier uniquely associated with the registered email account using the stored private key; and
transmitting an electronic message including the encrypted sender identifier from the sender device to an email server.

14. The method of claim 1, further comprising transmitting the public key associated with the registered email account to the email server.

15. The method of claim 1, further comprising receiving input of the electronic message addressed from the registered email account on the sender device.

16. The method of claim 1, wherein capturing biometric data comprises performing a fingerprint, facial, or iris scan of the user on the sender device.

17. The method of claim 1, further comprising validating on the email server that the sender device is authorized to send messages from the registered email account.

18. The method of claim 1, further comprising appending the encrypted sender identifier to the electronic message in a dedicated verification field.

19. The method of claim 1, further comprising querying a database on the email server to retrieve the stored public key associated with the sender device based on a received device identifier.

20. The method of claim 1, further comprising displaying visual indicators of verified or unverified status on a recipient device based on decryption of the encrypted sender identifier.
